(19) United States
(12) Patent Application Publication
(10) Pub. No.: US 2024/0215584 A1
(43) Pub. Date: Jul. 4, 2024

(54) ARTICLE HAVING ANTIVIRAL PROPERTIES, ARTICLE HAVING ANTIMICROBIAL PROPERTIES, AND ARTICLE HAVING ANTIFUNGAL PROPERTIES

(71) Applicant: NATIONAL INSTITUTE OF ADVANCED INDUSTRIAL SCIENCE AND TECHNOLOGY, Tokyo (JP)

(72) Inventors: Takeji Ueda, Okayama-shi (JP); Yoichi Yamada, Okayama-shi (JP); Jun Akedo, Tsukuba-shi (JP); Taku Goto, Tsukuba-shi (JP); Hisato Kato, Okayama-shi (JP)

(21) Appl. No.: 18/599,625

(22) Filed: Mar. 8, 2024

Related U.S. Application Data
(63) Continuation of application No. PCT/JP2022/037573, filed on Oct. 7, 2022.

(30) Foreign Application Priority Data
Oct. 13, 2021 (JP) 2021-168347

(51) Int. Cl. A01N 47/44; A01P 1/00; A01P 3/00

(52) U.S. Cl. CPC A01N 47/44; A01P 1/00; A01P 3/00

(57) ABSTRACT

An antiviral agent has a solvent and a low-solubility chlorhexidine. An article has an antiviral property in which a low-solubility chlorhexidine having solubility of 150 mg/100 mL or less in water at 20° C. is applied on a base material. An antimicrobial agent has a solvent and a low-solubility chlorhexidine. An article has an antimicrobial property in which a low-solubility chlorhexidine having solubility of 150 mg/100 mL or less in water at 20° C. is applied on a base material. An antifungal agent has a solvent and a low-solubility chlorhexidine. An article has an antifungal property in which a low-solubility chlorhexidine having solubility of 150 mg/100 mL or less in water at 20° C. is applied on a base material.

### CROSS-REFERENCE TO RELATED APPLICATIONS

This application is a Continuation of International Patent Application No. PCT/JP2022/037573, filed on Oct. 7, 2022, which claims the benefit of priority to Japanese Patent Application No. 2021-168347, filed on Oct. 13, 2021, the entire contents of which are incorporated herein by reference.

### FIELD

The present invention relates to an antiviral agent, a method for imparting antiviral properties, an article having antiviral properties, an antibacterial agent, an article having antibacterial properties, an antifungal agent, and an article having antifungal properties, which can be applied to everyday items such as tools and clothing used in medical and nursing care sites and daily life, as well as building materials.

### BACKGROUND

In recent years, infectious diseases such as noroviruses and coronavirus (COVID-19) which are highly resistant are becoming increasingly prevalent. In addition, as a route of infection of droplet infections by not only viruses but also bacteria, fungi, and the like, contact infections through fingers touching articles contaminated with these pathogens are known. As a countermeasure against such infectious diseases, it is strongly desired to remove pathogens adhering to articles.

Antiviral agents, antimicrobial agents, and antifungal agents are used in health care facilities to treat infectious diseases. In recent years, with the use of drugs, various resistant viruses, drug-resistant bacteria, and drug-resistant fungi that have acquired resistance to these drugs have appeared. It is known that these resistant viruses, resistant bacteria, and resistant fungi acquire drastic resistance to drugs due to inactivation of drugs, changes in drug action sites, production of drug alternative enzymes, and the like. Most of them are structural changes in part of a vicinity of a drug target site, and almost no extreme changes in the structure of the body occur in terms of survival. Infections caused by such drug-resistant viruses, drug-resistant bacteria, and drug-resistant fungi have become a major social problem due to the limited number of therapeutic drugs that can be used for treatment.

For example, a “norovirus” which belongs to the genus Norovirus of the family Caliciviridae, is an RNA type virus with only RNA, has a structure so as to cover RNA with a protein shell called capsid, and does not have a membrane composed of sugars and lipids called envelopes. Generally, viruses which have envelopes can be inactivated because the drug easily destroys the envelope and prevents it from binding to host cell receptors. However, since noroviruses do not have this envelope, noroviruses are resistant to drugs.

Patent Literature 1 (Japanese Laid-Open Patent Publication No. 2008-189645) discloses that a composition comprising three components of a lower alcohol, an alkaline substance, and a cationic surfactant has an inactive effect on norovirus. It is described that benzalkonium chloride, didecyldimethylammonium chloride, benzethonium chloride, chlorhexidine gluconate, and the like are used as the cationic surfactant.

Chlorhexidine itself has low solubility and is therefore widely used as chlorhexidine gluconate as a commonly used disinfectant. Non-Patent Literature 1 (Yassamin N. Albayatya, Enzyme responsivecopolymer micelles enhance the anti-biofilm efficacy of the antisepticchlorhexidine, International Journal of Pharmaceutics, Volume 566, 2019, pp. 329-341) discusses the reason why chlorhexidine gluconate is highly soluble. Chlorhexidine gluconate is believed to be highly soluble by masking the lipophilic portion of chlorhexidine with hybridized micelles. In this case, although gluconic acid is present in the hybridized micelles to help increase solubility, chlorhexidine is masked by the mixed micelles, which may weaken the aggressiveness to microorganisms.

### SUMMARY

The present inventors have found that, the persistence of an antiviral effect, an antibacterial effect, or an antifungal effect can be improved by using a low-solubility salt such as anion-free chlorhexidine or anion-free chlorhexidine hydrochloride (collectively referred to as low-solubility chlorhexidine) rather than one whose solubility is increased by the action of acid-derived anions such as gluconic acid or acetic acid.

An antiviral agent according to an embodiment of the present invention includes a solvent and a low-solubility chlorhexidine.

In the antiviral agent, a solubility of the low-solubility chlorhexidine is 150 mg/100 mL or less. The solubility of chlorhexidine, which is typical, is 80 mg/100 mL in water at 20° C.

In the antiviral agent, a concentration of the low-solubility chlorhexidine is 0.0016% by mass to 0.15% by mass.

In the antiviral agent, the solvent is at least one of methyl acetate, acetone, alcohol, and water.

In the antiviral agent, enveloped and/or non-enveloped viruses are inactivated.

In the antiviral agent, the non-enveloped virus are feline calicivirus.

In the antiviral agent, ZnO nanoparticles are further included as an additive.

In the antiviral agent, any one of alkyldiaminoethylglycine hydrochloride, alkyl betaine, or alkylamine oxide is further included as an additive.

In the antiviral agent, any one of alkyl glycoside, fatty acid alkanolamide, or polyoxyethylene alkyl ether is further included as an additive.

A method for imparting antiviral properties according to an embodiment of the present application includes applying or spraying the antiviral agent described above to a base material, or impregnating the base material with the antiviral agent, and then evaporating the solvent to attach low-solubility chlorhexidine having solubility of 150 mg/100 mL in water at 20° C. to the base material.

An article having an antiviral effect according to an embodiment of the present application is arranged with a low-solubility chlorhexidine having solubility of 150 mg/100 mL or less at 20° C. applied on a base material.

In the articles having an antiviral effect, the low-solubility chlorhexidine applied on the base material is 0.01 μg/cm² or more. An upper limit concentration C at which the low-solubility chlorhexidine is applied on the base material is defined by the following formula (1).

$$C = 1000 tp ρ [ mg / {cm}^{2} ] \qquad ( 1 )$$

However, t (cm) is a thickness of a membrane or layer on a surface to be penetrated (1×10⁻⁵<t<0.3), in the case of a porous membrane, p is porosity, and in the case of a resin material, p is critical volume ratio of permeating components to a base material (dimensionless, 0.01<p<0.9). ρ is a density of the low-solubility chlorhexidine (0.8<ρ<2.2, typical 1.4 g/cm³). If chlorhexidine is applied at a concentration higher than the upper limit concentration C specified here, chlorhexidine overflows from the base material and is unsuitable for use due to poor skin feel, occurrence of wetting, or generation of a powder on the surface. A typical upper limit concentration C of 1 mg/cm² or less is desirable in the case where the low-solubility chlorhexidine having a thickness of 10 μm and a density of 1.4 g/cm³ penetrates at a volume fraction of 70%.

In the article having an antiviral effect, the base material is made of fiber, paper, cloth, resin, metal, or ceramics. Although chlorhexidine, which has lower solubility than gluconate, has higher hydrophobicity and tends to spread uniformly on a hydrophobic surface, wettability can be appropriately adjusted by compositions of the antiviral agent.

An antimicrobial agent according to an embodiment of the present invention includes a solvent and a low-solubility chlorhexidine. In addition, in an article having antimicrobial properties according to an embodiment of the present application, chlorhexidine having solubility of 150 mg/100 mL or less in water at 20° C. is applied on a base material.

An antifungal agent according to an embodiment of the present invention includes a solvent and a low-solubility chlorhexidine. In addition, in an article having antifungal properties according to an embodiment of the present application, chlorhexidine having solubility of 150 mg/100 mL or less in water at 20° C. is applied on the base material.

According to an embodiment of the present invention, the persistence of an antiviral effect, an antibacterial effect, or an antifungal effect can be improved.

### BRIEF DESCRIPTION OF DRAWINGS

FIG. 1A is the chemical formula of chlorhexidine.

FIG. 1B is a schematic representation of the chemical formula of chlorhexidine.

FIG. 2A is a drawing for explaining the mechanism by which chlorhexidine destroys envelopes.

FIG. 2B is a drawing for explaining the mechanism by which chlorhexidine destroys membrane proteins.

FIG. 3 is a graph showing a relationship between time (min) and residual viruses (PFU/mL).

FIG. 4A is a diagram for explaining an outline of an ISO21702 compliance test.

FIG. 4B is a diagram for explaining an outline of the ISO21702 compliance test.

FIG. 4C is a diagram for explaining an outline of the ISO21702 compliance test.

FIG. 4D is a diagram for explaining an outline of the ISO21702 compliance test.

FIG. 5 is a graph showing a relationship between ultrasonic cleaning time (min) and residual volume (μg/cm²).

FIG. 6 is a result of a calcein efflux rate for a viral composition artificial membrane.

FIG. 7 is a result of a calcein efflux rate for the bacterial composition artificial membrane.

FIG. 8 is a result of measuring a destructive action of erythrocytes on chlorhexidine gluconate and chlorhexidine.

### DESCRIPTION OF EMBODIMENTS

As mentioned above, chlorhexidine gluconate is known for its high solubility. Therefore, even when a solvent containing chlorhexidine gluconate or chlorhexidine gluconate is applied to a surface of a base material as an antiviral agent, an antibacterial agent, or an antifungal agent, the chlorhexidine gluconate is eluted by moisture adhering to the surface of the base material. Therefore, there is a problem whereby the persistence of an antiviral effect on the surface of the base material becomes low.

In view of the above problems, in an embodiment of the present invention, one object is to improve the persistence of an antiviral effect, an antibacterial effect, or an antifungal effect.

Hereinafter, an embodiment of the present invention will be described in detail with reference to the drawings. The present invention is not limited to the following embodiments, and can be variously modified within the scope of the gist thereof.

In the present specification and the like, chlorhexidine (molecular formula: C₂₂H₃₀Cl₂N₁₀) has a molecular weight of 505.4, solubility of about 80 mg/100 mL, and a length of 2.5 nm to 3.5 nm. Chlorhexidine has low solubility and is positively charged. The chemical formula of chlorhexidine is exemplified below.

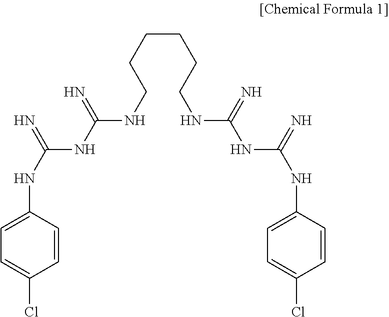 [SMILES: N=C(NCCCCCCNC(=N)NC(=N)Nc1ccc(Cl)cc1)NC(=N)Nc1ccc(Cl)cc1]

In the present specification and the like, chlorhexidine gluconate (C₂₂H₃₀Cl₂N₁₀(C₆H₁₂O₇)₂) has a molecular weight of 897.8 and 21000 mg/100 mL or more. The chemical formula of chlorhexidine gluconate is exemplified below.

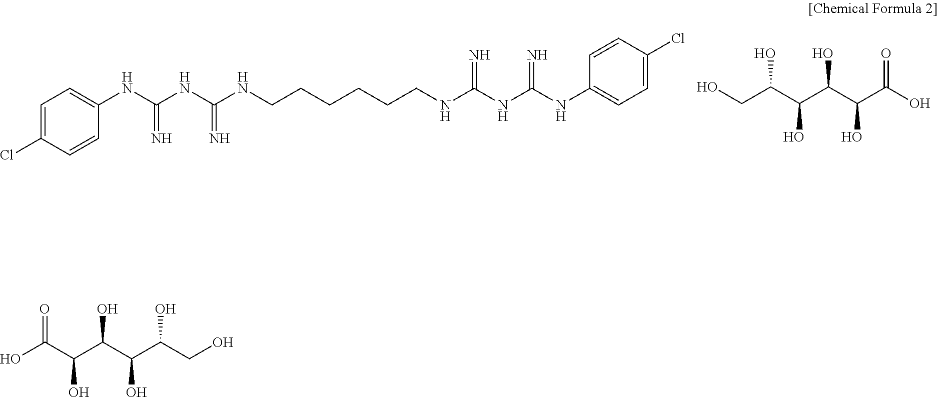 [SMILES: N=C(NCCCCCCNC(=N)NC(=N)Nc1ccc(Cl)cc1)NC(=N)Nc1ccc(Cl)cc1 ; O=C(O)[C@@H](O)[C@H](O)[C@@H](O)[C@@H](O)CO ; O=C(O)[C@H](O)[C@@H](O)[C@H](O)[C@H](O)CO]

In this specification and the like, chlorhexidine (molecular formulae: C₂₂H₃₀Cl₂N₁₀) is simply referred to as chlorhexidine and refers to anion-free chlorhexidine derived from acids such as gluconic acid, acetic acid, and hydrochloric acid. In this specification and the like, chlorhexidine does not include salts such as chlorhexidine gluconate, chlorhexidine hydrochloride, chlorhexidine phosphanylate, chlorhexidine acetate, and the like. For example, the saturation concentration of chlorhexidine gluconate is 21000 mg/100 mL or more and the chlorhexidine acetate is 1820 mg/100 mL. Here, chlorhexidine hydrochloride is about 60 mg/100 mL. Chlorhexidine hydrochloride is an example of a low-solubility chlorhexidine and can be used in the following embodiments as well as chlorhexidine.

### First Embodiment

In the present embodiment, an antiviral agent having an antiviral effect according to an embodiment of the present invention will be described. In this specification and the like, the antiviral effect means inactivation of pathogen viruses.

An antiviral agent according to an embodiment of the present invention exhibits an antiviral effect against an enveloped virus and a non-enveloped virus. An antiviral agent exhibits for example a high viral inactivating action against a caliciviridae virus as the non-enveloped virus, a higher viral inactivating action against viruses of the genus vesivirus and/or viruses of the genus norovirus, and a particularly high viral inactivating action against at least one virus selected from a group consisting of a feline calicivirus, a murine norovirus, and a human norovirus. In addition, the antiviral agent exhibits a virus inactivating action not only on the non-enveloped viruses described above, but also on rotaviruses, polioviruses, adenoviruses, and the like.

In addition, examples of the enveloped viruses include SARS coronavirus, highly pathogenic avian influenza virus, MARS coronavirus, Ebola virus, coronavirus (COVID-19), smallpox virus, hepatitis B virus, measles virus, and rabies virus. The antiviral agent also has a viral inactivating action on these enveloped viruses.

Viruses are prone to errors in genetic information during propagation and replication. Therefore, it is known that the viruses have a high mutation rate, and the mutant strains appear one after another. Such mutations often occur in spike proteins, and the like, and the effects of a vaccine and the like are affected. An antiviral agent according to an embodiment of the present invention also exhibits a viral inactivating action on the mutant strains of the viruses.

### [Composition of Antiviral Agent]

An antiviral agent according to an embodiment of the present invention includes a solvent and a low-solubility chlorhexidine.

As noted above, the solubility of chlorhexidine in water at 20° C., which is representative of the low solubility chlorhexidine, is 80 mg/100 mL. In general, chlorhexidine is often used as chlorhexidine gluconate. The solubility of chlorhexidine gluconate is 21000 mg/100 mL or more in water at 20° C. and is greater than the solubility of chlorhexidine in water at 20° C. When used as an antiviral agent according to an embodiment of the present invention, the low-solubility chlorhexidine having lower solubility than chlorhexidine gluconate is used.

Chlorhexidine gluconate is commercially available as a disinfectant and 0.1% to 0.5% is used to disinfect fingers, skin, and the like and 0.05% is used to disinfect wound sites. Even at such low concentrations, an anaphylactic shock may occur if Chlorhexidine gluconate is used on the mucosa of the human body. Therefore, even in the case where the low-solubility chlorhexidine is used as the antiviral agent, the concentration of low-solubility chlorhexidine contained in the antiviral agent is preferably lower in consideration of the effect on the human body in the case where the antiviral agent is used unintentionally on the mucosa.

In the antiviral agent, in the case where the concentration of the low-solubility chlorhexidine is 0.0016% by mass or more and 0.15% by mass or less, the antiviral effect can be exhibited. This concentration is sufficiently low compared to the concentration of chlorhexidine gluconate, such as commonly used disinfectants, to ensure safety to the human body. Further, in the antiviral agent, in the case where the concentration of the low-solubility chlorhexidine is more than 0.028% by mass and 0.08% by mass or less, it is possible to further ensure safety to the human body. In addition, even when the concentration of the low-solubility chlorhexidine is 0.000051% by mass, the low-solubility chlorhexidine has the action of attacking the viruses and destroying the envelope.

As the solvent, at least one of ethyl acetate, acetone, alcohol, or water is used.

For example, in the case where the antiviral agent is applied to a base material having hydrophilicity such as a fiber, paper, or metal, resin, or ceramics having hydrophilicity imparted to a surface, it is preferable to use a polar solvent such as water, ethanol, or acetone. Permeability of chlorhexidine to the surface of the base material can be improved by using the polar solvent described above. In addition, chlorhexidine can be uniformly applied on the surface of the base material.

For example, in the case where the antiviral agent is applied to a resin such as plastic and rubber, or a hydrophobic base material such as a ceramics, a metal or cloth having a hydrophobic surface, it is preferable to use a solvent having a low polarity or no polarity. Permeability of chlorhexidine to the surface of the base material can be improved by using the solvent described above. In addition, chlorhexidine can be uniformly applied on the surface of the base material.

In the case where antiviral agents are used on fiber, paper, or fabric base materials, a water-based or alcohol-based organic solvent is used. As the alcohol-based organic solvent, for example, ethanol or isopropyl alcohol is used. Further, mixed aqueous solutions thereof are also suitable.

In the case where the antiviral agent is used for a plastic-based base material, an ester-based, ketone-based, or alcohol-based organic solvent is used. As the ester-based organic solvent, for example, ethyl acetate is used. As the ketone-based organic solvent, for example, acetone is used, and as the alcohol-based solvent, for example, ethanol is used.

In the case where the antiviral agent is used for a ceramics-based base material, a water-based, ketone-based, or ester-based organic solvent is used. As the ketone-based organic solvent, for example, acetone is used. As the ester-based organic solvent, for example, ethyl acetate is used.

In the case where the antiviral agent is used for a metal-based base material, a ketone-based or ester-based organic solvent is used. As the ketone-based organic solvent, for example, acetone is used. As the ester-based organic solvent, for example, ethyl acetate is used.

If necessary, the antiviral agent may contain an additive in addition to the components described above.

As the additive, metal-oxide nanoparticles such as ZnO nanoparticles or TiO nanoparticles may be used. The antiviral agent preferably comprises 0.1% to 30% by weight of ZnO nanoparticles in a solution state and 1% to 60% by weight of the solute residue when the solvent is evaporated and applied on the base material. Decomposition of dissolved components of the antiviral agent such as the low-solubility chlorhexidine due to UV rays can be suppressed by including ZnO nanoparticles as the additive, and weather resistance can be improved. It is desirable that ZnO nanoparticles have a diameter of 10 nm or more and 40 nm or less.

As the additive, an amphoteric surfactant such as alkyldiaminoethylglycine hydrochloride, alkylbetaines, or alkylamine oxides may be used. The antiviral effect can be improved by containing 0.1% by mass to 30% by mass of the amphoteric surfactant as the additive.

As the additive, a nonionic surfactant such as alkyl glycoside, fatty acid alkanolamide, or polyoxyethylene alkyl ether may be used. The antiviral effect can be improved by containing 0.1% by mass to 30% by mass of the nonionic surfactant as the additive.

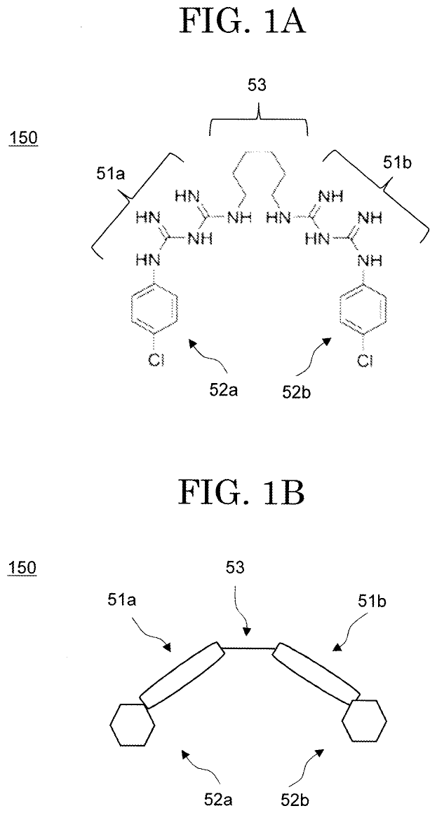

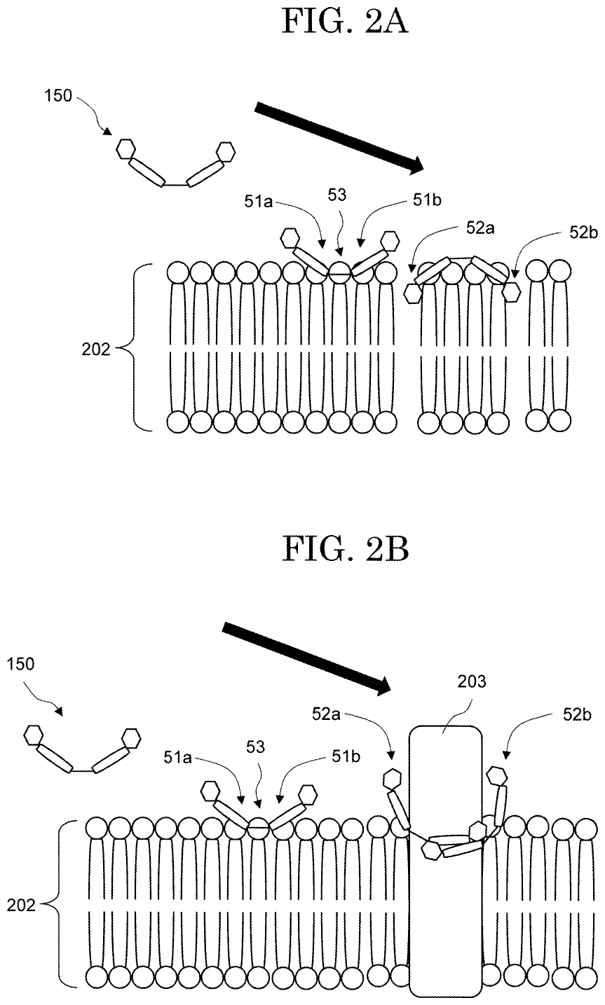

Next, the mechanism by which chlorhexidine destroys viruses will be described referring to FIG. 1A to FIG. 2B. FIG. 1A is the chemical formula of chlorhexidine 150. FIG. 1B is a schematic diagram of the chemical formula of chlorhexidine. In FIG. 1B, chlorhexidine has structures 51a and 51b having many positive charges, large structures 52a and 52b, and a highly hydrophobic structure 53 connecting the structure 51a and the structure 51b. The large structures 52a and 52b are six-membered rings.

FIG. 2A is a diagram for explaining the mechanism by which chlorhexidine destroys an envelope 202. The chlorhexidine 150 is positively charged due to its high content of N. Therefore, when the chlorhexidine 150 approaches the envelope 202, negative charges on the envelope 202 are used to approach the envelope (direction of arrow in FIG. 2A). However, many positive charges are required to bind firmly to a surface of the envelope 202. Subsequently, the large structures 52a and 52b, and the structure 53 such as six-membered rings can be inserted into a surface of a membrane to greatly disturb the stability of the lipidic membrane. In addition, since the positive charge of chlorhexidine and the negative charge of the surface of the envelope 202 are firmly bonded to each other, it is possible to prevent the chlorhexidine from being peeled off from the surface of the envelope 202. In addition, a hydrophobic group of chlorhexidine can destabilize the envelope 202.

FIG. 2B is a diagram for explaining the mechanism by which chlorhexidine destroys membrane proteins (for example, spikes 203). The mechanism by which chlorhexidine approaches the envelope 202 is as described in FIG. 2A. However, many positive charges are required to bind firmly to the surface of the envelope 202. Subsequently, the large structures 52a and 52b, such as six-membered rings, and part of the positive charges, and the highly hydrophobic structure 53 bind to the spike 203, greatly disrupting the stability of the spike 203.

An antiviral agent according to an embodiment of the present invention utilizes such a mechanism by which chlorhexidine destroys viruses. Since the solubility of chlorhexidine is sufficiently low as compared to chlorhexidine gluconate, it is possible to prevent chlorhexidine from eluting into moisture adhering to a surface of a base material. An antiviral effect of chlorhexidine attached to the surface of the base material can be sustained over an extended period of time. That is, persistence of the antiviral effect on an article can be improved.

### [Method for Imparting Antiviral Properties]

Next, a method for imparting an antiviral effect to an article using an antiviral agent according to an embodiment of the present invention will be explained.

Examples of a base material include fiber, paper, cloth, plastic, or resin such as rubber, metal, and ceramics, and the material is not particularly limited. The base material may be a hard solid such as, metal, wood, stainless, glass, plastic (polyethylene, PET, acrylic resins, melamine resins, polyvinyl chloride, or the like), or ceramics, or may be a deformable solid such as fibers, papers, fabrics, rubber sheets, sponges, metal foils, or thin film-like films.

The antiviral agent is attached to the base material by spraying or coating. In addition, the antiviral agent may be attached to the base material by impregnating the base material with the antiviral agent.

Next, a solvent contained in the antiviral agent attached to the base material is evaporated. Examples of a method for evaporating the solvent include natural drying and infrared irradiation. Through the above steps, the low-solubility chlorhexidine having solubility of 150 mg/100 mL or less in water at 20° C. can be attached to the base material. That is, antiviral properties can be imparted to the article.

### [Article Having Antiviral Properties]

In an article having antiviral properties by using the above-mentioned methods of imparting antiviral properties according to an embodiment of the present application, chlorhexidine having solubility of 80 mg/100 mL in water at 20° C. is applied on a surface of a base material. In an article having antiviral properties, in the case where a droplet containing viruses adheres to the surface of the base material, chlorhexidine applied on the base material can attack, destroy, and inactivate the viruses.

In the case where chlorhexidine gluconate is used as an antiviral agent, chlorhexidine gluconate has high solubility, and therefore, even when the antiviral agent is attached to the base material, when a droplet of the viruses or other moisture is attached to the surface of the base material, chlorhexidine gluconate is eluted. Therefore, depending on the concentration of chlorhexidine gluconate, there is a risk of an anaphylactic shock to the human body if chlorhexidine gluconate is eluted. There is also a problem that an antiviral effect on the article is less persistent.

Further, in the article having antiviral properties according to the present application, chlorhexidine applied on the base material is 0.01 μg/cm² or more. An upper limit concentration C of the chlorhexidine applied on the base material is defined by the following formula (1).

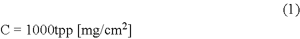

However, t (cm) is a thickness of a membrane or layer on a surface to be penetrated (1×10⁻⁵<t<0.3), in the case of a porous membrane, p is porosity, and in the case of a resin material, p is a critical volume ratio of permeating components to a base material (dimensionless, 0.01<p<0.9). ρ is the density of the low-solubility chlorhexidine (0.8<ρ<2.2, typical 1.4 g/cm³). Chlorhexidine can destroy and inactivate viruses even at very low concentrations. Chlorhexidine is a substance also used for oral care. Even if chlorhexidine is eluted in water or the like, safety to the human body can be ensured. If chlorhexidine is applied at a concentration higher than the upper limit concentration C specified here, chlorhexidine overflows from the base material and is unsuitable for use due to poor skin feel, occurrence of wetting, or generation of a powder on the surface. A typical upper limit concentration C of 1 mg/cm² is desirable or less in the case where the low-solubility chlorhexidine having a thickness of 10 μm and a density of 1.4 g/cm³ penetrates at a volume fraction of 70%.

In addition, since the solubility of chlorhexidine is sufficiently low as compared with chlorhexidine gluconate, it is possible to suppress chlorhexidine from eluting into the moisture adhering to the surface of the base material. The antiviral effect of chlorhexidine attached to the surface of the base material can be sustained over an extended period of time. That is, the persistence of the antiviral effect on the article can be improved.

In the case where the antiviral article is used for an extended period of time, the base material may be sprayed or coated with the antiviral agent, or the base material may be impregnated with the antiviral agent to evaporate the solvent. Therefore, it is possible to repeatedly impart the antiviral properties to the article.

In addition, in the case where plastic is used as the base material, depending on the type of plastic and type of solvent contained in the antiviral agent, a surface of the plastic may be attacked by the solvent, and chlorhexidine may penetrate into the plastic. When a droplet of viruses or other moisture adhere to the surface of such an article, chlorhexidine is slowly released from the interior of the plastic. Sustained release of chlorhexidine can attack, destroy, and inactivate viruses.

In addition, the antiviral agent using chlorhexidine can inactivate the viruses in a short time.

As mentioned above, chlorhexidine itself has low solubility and is therefore widely used as chlorhexidine gluconate as a commonly used disinfectant. Non-Patent Literature 1 discusses a reason why solubility of chlorhexidine gluconate is high. Chlorhexidine gluconate is believed to be highly soluble by masking the lipophilic portion of chlorhexidine with hybridized micelles. In this case, although gluconic acid is present in the hybridized micelles to help increase solubility, chlorhexidine is masked by the mixed micelles, which may weaken aggressiveness to microorganisms.

An article having antiviral properties according to an embodiment of the present invention has the low-solubility chlorhexidine. Even if the low-solubility chlorhexidine is eluted into moisture, it is not masked by the hybridized micelles and can be present in the moisture alone. Therefore, an antimicrobial effect of chlorhexidine does not diminish, and it is considered that chlorhexidine also has an antiviral effect against non-enveloped viruses. It was not known that anion-free chlorhexidine derived from gluconic acid, acetic acid, hydrochloric acid, or the like, has an antiviral effect against non-enveloped viruses, and it has been found for the first time by the present inventors.

An article for applying an antiviral agent to a surface according to an embodiment of the present invention includes, for example, a door knob, an electric switch, a keyboard, or a handrail that is touched by a human hand, or footwear, clothing, a side pad, or the like that is touched by human sweat. Further, examples of the article include a floor material of a toilet, a toilet seat, a seat surface of a passenger car such as a taxi, and a water purification or air conditioner filter. Further, examples of the article include a seat and a strap of a train, a handrail of an escalator, a building material of a building, a packaging material, and the like. In this way, the antiviral agent according to an embodiment of the present invention can be applied to a wide variety of articles.

In addition, face masks, which are generally used as etiquettes because their effectiveness is pointed out in the prevention of infections spreading, are usually made of cloth (nonwoven fabric), paper, or the like, and are therefore opaque, and therefore have problems that interfere with reading other person's facial expressions and deaf person's reading of the lips of a cross-talker during a conversation. On the other hand, if an antiviral agent having high antiviral properties and high maintenance properties is applied to the transparent resin film by the present invention, a material having an antiviral effect in addition to transparency and flexibility can be provided. In addition, if the antiviral agent is partially used in an area surrounding the lips of the mask, it is possible to read the facial expression and movement of the lips during conversation, and safety is greatly improved even if the mask is used for a long time due to the antiviral effect thereof.

### Second Embodiment

In this embodiment, an antibacterial agent having an antibacterial effect according to an embodiment of the present invention will be described. In this specification and the like, the “antibacterial effect” is a concept including a bactericidal effect and an antibacterial effect. That is, it is considered to have the “antibacterial effect” in the case where not only an action of reducing the viable count of a specific bacterium but also an action of suppressing the growth speed of a specific bacterium is confirmed.

An antimicrobial agent according to an embodiment of the invention antibacterial effects against, for example, methicillin-sensitive exhibits Staphylococcus aureus, methicillin-resistant Staphylococcus aureus, vancomycin moderate resistant Staphylococcus aureus, Pseudomonas aeruginosa wild strains, Pseudomonas aeruginosa resistance gene quadruple disruption strains, faecalis bacteria, and vancomycin-resistant faecalis bacteria. In addition, an antimicrobial agent according to an embodiment of the present application also exhibits an antimicrobial effect against resistant bacteria such as carbapenem-resistant Enterobacteriaceae, penicillin-resistant pneumococcus, base material-extended beta-lactamase producing bacteria, AmpC producing bacteria, multidrug-resistant Pseudomonas aeruginosa, and drug-resistant Acinetobacter. A site of action of chlorhexidine is a bacterial cell membrane (lipid membrane). Therefore, an antibacterial agent according to an embodiment of the present invention exhibits the same antibacterial effect on bacteria and resistant bacteria other than those exemplified above.

### [Configuration of Antimicrobial Agent]

An antimicrobial agent according to an embodiment of the present invention includes a solvent and the low-solubility chlorhexidine. As the low-solubility chlorhexidine and the solvent that can be used as the antimicrobial agent, the same low-solubility chlorhexidine and the same solvent as those described in the first embodiment can be used, and therefore, for a detailed description, reference may be made to the first embodiment.

In the antimicrobial agent, in the case where the concentration of the low-solubility chlorhexidine is 0.0016% by mass or more and 0.15% by mass or less, the antimicrobial agent can exhibit an effect of attacking and reducing bacteria. Further, in the antibacterial agent, in the case where the concentration of the low-solubility chlorhexidine is more than 0.028% by mass and 0.08% by mass or less, it is possible to further ensure safety to the human body. Further, as the bacteriostatic effect, the concentration of the low-solubility chlorhexidine may be at least 0.00005% by mass or more. If the concentration of the low-solubility chlorhexidine is 0.00005% by mass or more, the growth of bacteria can be prevented and the growth speed of bacteria can be suppressed.

### [Method for Imparting Antimicrobial Properties]

Next, a method for imparting an antimicrobial effect to an article using an antimicrobial agent according to an embodiment of the present invention will be described. In addition, as a base material capable of imparting an antibacterial effect, a base material similar to the base material described in the first embodiment can be used.

The base material is adhered by spraying or coating the antimicrobial agent. Further, the base material may be impregnated with the antimicrobial agent to adhere the antimicrobial agent to the base material.

Next, a solvent contained in the antimicrobial agent adhered to the base material is evaporated. Examples of the method for evaporating the solvent include natural drying, infrared irradiation, and the like. Through the above steps, the low-solubility chlorhexidine having solubility of 150 mg/100 mL or less in water at 20° C. can be attached to the base material. This can impart antimicrobial properties to the article.

### [Article Having Antimicrobial Properties]

Chlorhexidine having solubility of 80 mg/100 mL in water at 20° C. is applied on a surface of a base material by using the method for imparting antimicrobial properties described above, in an article having antimicrobial properties according to an embodiment of the present application. In articles having antimicrobial properties, in the case where bacteria adhere to a surface of the base material, chlorhexidine applied on the base material can attack, destroy, and inactivate the bacteria.

Further, in the article having antimicrobial properties according to the present application, chlorhexidine applied on the base material is 0.01 μg/cm² or more. The upper limit concentration C of the chlorhexidine applied on the base material is defined by the formula (1) described in the first embodiment.

A mechanism by which chlorhexidine destroys bacteria is similar to that by which it destroys viruses. Chlorhexidine is charged by containing a large amount of N. Therefore, in the case where chlorhexidine approaches cell membranes of bacteria, it approaches by utilizing negative charges on a cell membrane surface. The large structures 52a and 52b, such as the six-membered rings of chlorhexidine, and the structure 53 are inserted into the surface of the cell membrane, so that the stability of the cell membrane can be greatly disturbed. In addition, since positive charges of chlorhexidine and the negative charges on the surface of the cell membrane are strongly bound to each other, it is possible to prevent chlorhexidine from being peeled off from the surface of the cell membrane. In addition, the hydrophobic group of chlorhexidine can destabilize the envelope. Further, large structures 52a and 52b, such as six-membered rings, some of the positive charges, and the highly hydrophobic structure 53 bind to surface proteins of bacteria and greatly disrupt the stability of the surface proteins.

An antimicrobial agent according to an embodiment of the present invention utilizes a mechanism by which chlorhexidine destroys bacillus. Since the solubility of chlorhexidine is sufficiently low as compared to chlorhexidine gluconate, it is possible to prevent chlorhexidine from eluting into moisture adhering to a surface of a base material. An antimicrobial effect of chlorhexidine attached to the surface of the base material can be sustained over a long period of time. That is, persistence of the antimicrobial effect on the article can be improved.

### Third Embodiment

The present embodiment will describe an antifungal agent having an antifungal effect according to an embodiment of the present invention. The term “antifungal effect” in the present specification and the like is a concept including a fungicidal effect and a fungal growth inhibiting effect. That is, it is considered to have the “antifungal effect” in the case where not only an effect of reducing the viable count of specific fungi but also an effect of suppressing the growth speed of specific fungi is confirmed.

An antifungal agent according to an embodiment of the invention also exhibits an antifungal effect on Aspergillus genus, Cryptococcus genus, Pneumocystis genus, Trichosporon genus, Trichophyton genus, Sporothrix genus, Dematiaceous fungus, Malassezia genus, Fusarium genus, Trichothecium genus, Cepharosporium genus, Rhzioctonia genus, Ceratobasidium genus, Magnaporthe genus, Ophiostoma genus, Cryphonectria genus, Ustilago genus, and Alternaria genus. An antifungal agent according to an embodiment of the present invention specifically exhibits an antifungal effect against Candida. A site of action of chlorhexidine is the cell membrane (lipid membrane) of the fungi. Therefore, an antifungal agent according to an embodiment of the present invention exhibits an antifungal effect in the same way for fungi other than those exemplified above.

### [Configuration of Antifungal Agent]

An antifungal agent according to an embodiment of the present invention includes a solvent and the low-solubility chlorhexidine. As the low-solubility chlorhexidine and the solvent that can be used as the antifungal agent, the same as those described in the first embodiment can be used, and therefore, for a detailed description, reference may be made to the first embodiment.

In the antifungal agent, in the case where the concentration of the low-solubility chlorhexidine is 0.0016% by mass or more and 0.15% by mass or less, an effect of attacking and reducing the fungi can be exhibited. Further, in the antifungal agent, in the case where the concentration of the low-solubility chlorhexidine is more than 0.028% by mass and 0.08% by mass or less, it is possible to further ensure safety to the human body. Further, as a fungal growth inhibiting effect, the concentration of the low-solubility chlorhexidine may be at least 0.0002% by mass or more. If the concentration of the low-solubility chlorhexidine is 0.0002% by mass or more, the growth of the fungi can be prevented, and the growth speed of the fungi can be suppressed.

### [Method for Imparting Antifungal Agent]

Next, a method for imparting an antifungal effect to an article using an antifungal agent according to an embodiment of the present invention will be described. In addition, as a base material capable for imparting an antifungal effect, a base material similar to the base material described in the first embodiment can be used.

The antifungal agent is adhered to the base material by spraying or coating. The antifungal agent may be attached to the base material by impregnating the base material with the antifungal agent.

Next, the solvent contained in the antifungal agent attached to the base material is evaporated. Examples of the method for evaporating the solvent include natural drying, infrared irradiation, and the like. Through the above steps, the low-solubility chlorhexidine having solubility of 150 mg/100 mL or less in water at 20° C. can be attached to the base material. This can impart antifungal properties to the article.

### [Article Having Antifungal Properties]

In an article having antifungal properties according to an embodiment of the present application, chlorhexidine having solubility of 80 mg/100 mL in water at 20° C. is applied on a surface of a base material. In the article having the antifungal properties, in the case where fungi adhere to a surface of the base material, chlorhexidine applied on the base material can attack, destroy, and inactivate the fungi.

Further, in the article having antifungal properties according to the present application, chlorhexidine applied on the base material is 0.01 μg/cm² or more. An upper limit concentration C of chlorhexidine applied on the base material is defined by the formula (1) described in the first embodiment.

A mechanism by which chlorhexidine destroys fungi is similar to that by which it destroys viruses. Chlorhexidine is charged by containing a large amount of N. Thus, in the case where chlorhexidine approaches cell membranes of fungi, it uses negative charges on a cell membrane surface to approach it. The large structures 52a and 52b, such as the six-membered rings of chlorhexidine, and the structure 53 are inserted into the cell membrane, so that the stability of the cell membrane can be greatly disturbed. Since positive charges of chlorhexidine and the negative charges on the surface of the cell membrane are strongly bound to each other, it is possible to prevent chlorhexidine from being peeled off from the surface of the cell membrane. In addition, a hydrophobic group of chlorhexidine can destabilize the envelope. Also, large structures 52a and 52b such as six-membered rings, some of the positive charges and the highly hydrophobic structures 53 bind to surface proteins of the fungi and greatly disrupt the stability of surface proteins.

An antifungal agent according to an embodiment of the present invention utilizes a mechanism by which chlorhexidine destroys fungus. Since the solubility of chlorhexidine is sufficiently low as compared to chlorhexidine gluconate, it is possible to prevent chlorhexidine from eluting into moisture adhering to a surface of a base material. An antifungal effect of chlorhexidine attached to the surface of the base material can be sustained over a long period of time. That is, persistence of the antifungal effect on an article can be improved.

Although each of the antiviral agent, the antibacterial agent, and the antifungal agent has been described in the first to third embodiments, an embodiment of the present invention is not limited thereto. In an embodiment of the present invention, an antimicrobial agent may function as an antimicrobial agent with an antiviral effect, an antibacterial effect, and an antifungal effect. Here, microorganisms include viruses, bacteria, and fungi. The antimicrobial agent may include a solvent and the low-solubility chlorhexidine. In addition, in the case where the concentration of the low-solubility chlorhexidine in the antimicrobial agent is 0.0016% by mass or more and 0.15% by mass or less, the antimicrobial agent can have a combined antiviral effect, an antibacterial effect, and an antifungal effect. In addition, in the case where the concentration of the low-solubility chlorhexidine in the antimicrobial agent is more than 0.028% by mass and 0.08% by mass or less, the antimicrobial agent has a combined antiviral effect, an antibacterial effect, and an antifungal effect, and can further ensure safety to the human body. Further, for a detailed description of a composition of the antimicrobial agent, a method for imparting the antimicrobial property, and an article having antimicrobial properties, the description of each of the first to third embodiments can be referred to.

While embodiments of the invention have been described in detail above, it should be understood that modifications, variations, and changes can be made without departing from the scope of the claims.

In the present invention, it is understood that the present invention provides other effects that are different from the effects provided by the embodiments described above, and those that are obvious from the description of the present specification or those that can be easily predicted by a person skilled in the art are also included in the present invention.

### EXAMPLES

In this example, the results of verifying non-enveloped viral activity using an antiviral agent according to an embodiment of the present invention will be described.

### Example 1

In this example, feline calicivirus was used as a non-enveloped virus.

### Example 1

As a test sample, an aqueous solution containing 128 μg/ml of chlorhexidine was used.

### Comparative Example 1

As a comparative example 1, a buffer solution (PBS: Phosphate-buffered saline) was used.

### Comparative Example 2

As a comparative example 2, MilliQ was used.

A feline calicivirus suspension containing 685000 PFU/mL was added dropwise to each of the example 1, the comparative example 1, and the comparative example 2.

Active viral counts (PFU/mL) were counted with treatment times of 0, 0.5, 2, 10, and 30 minutes.

Table 1 summarizes the results of comparing the comparative example 1 and the comparative example 2 with the example 1. Chlorhexidine is referred to as CHX in the following tables or drawings.

TABLE 1

| | | | | Residual Virus Activity | | |
|---|---|---|---|---|---|---|
| | | | | | Residual | Inactivation |
| | Time(min) | PFU/mL | log(PFU/mL) | R | Rate (%) | Rate (%) |
| Comparative Example 1 | 0 | 685000 | 5.84 | — | — | — |
| (Control) | 30 | 606000 | 5.78 | — | 100 | — |
| Comparative Example 2 | 0 | 685000 | 5.84 | — | — | — |
| (MilliQ) | 30 | 590000 | 5.77 | — | 100 | — |
| Example 1 | 0 | 685000 | 5.84 | — | — | — |
| (CHX 128 μg/mL) | 0.5 | 765000 | 5.88 | — | 111.7 | −11.68 |
| | 2.0 | 505000 | 5.70 | — | 73.7 | 26.28 |
| | 10 | 190000 | 5.28 | — | 27.7 | 72.26 |
| | 30 | 6950 | 3.84 | 1.94 | 1.0 | 98.99 |

Here, the inactivation rate refers to a rate of inactivation of the viruses calculated from the number of active viruses (PFU/mL) of each of the control sample and the test sample. Here, the control sample was the comparative example 1, and the test sample was the example 1. The following formula was used to calculate the inactivation rate.

$$\frac{A - B}{A} \times 100 \qquad [ Mathematical Formula 1 ]$$

A: Number of viruses with activity in control sample (PFU/mL)
B: Number of viruses with activity in test sample (PFU/mL)

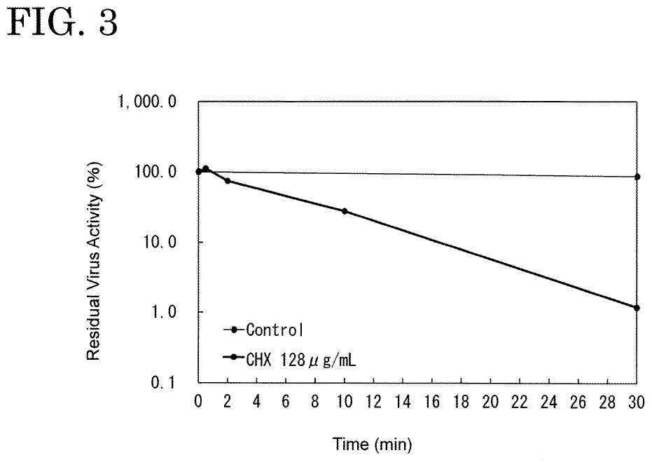

FIG. 3 is a graph showing a relationship between time (min) and residual viruses (PFU/mL). When the example 1 was compared with the comparative example 1, it was confirmed that the example 1 had a high antiviral effect with an inactivation rate of 98.82 after 30 minutes.

### Example 2

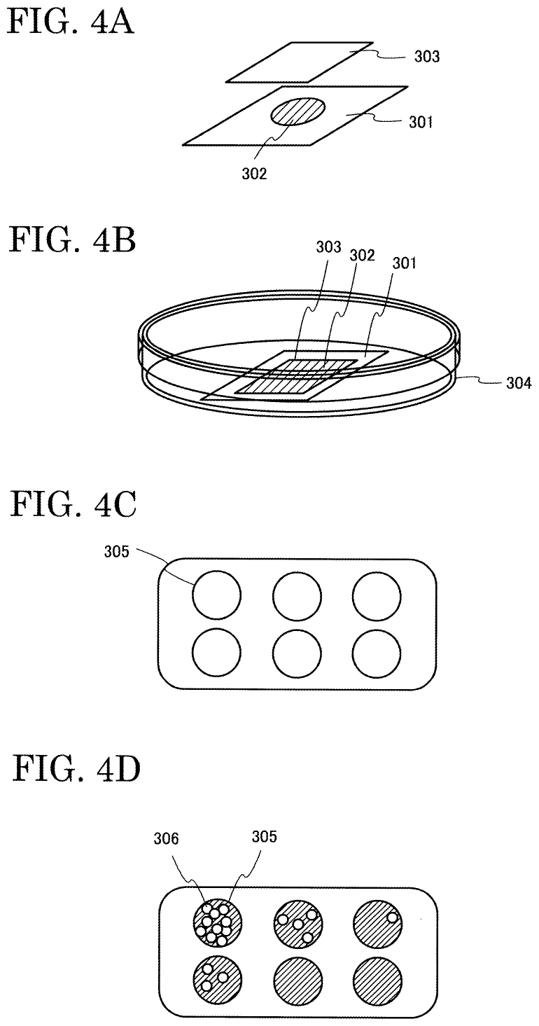

In this embodiment, an ISO21702 compliance test was performed using a feline calicivirus as a non-enveloped virus in the case where an antiviral agent is applied on a base material. FIG. 4A to FIG. 4D are diagrams for explaining an outline of the ISO21702 compliance test.

### Example 2

As an example 2, a 4 cm×4 cm porous membrane (nanoporous membrane) of 3 μm of alumina (Al₂O₃) was formed on a SUS substrate of 4 cm×4 cm by an AD method (Aerosol Deposition Method). The porous membrane was coated with 128 μg/day of chlorhexidine.

### Comparative Example 3

As a comparative example 3, a SUS substrate (4 cm×4 cm) was used.

Next, an outline of an antiviral test based on ISO21702 will be described.

As shown in FIG. 4A, 0.225 mL of a viral suspension 302 of feline calicivirus containing 10000000 PFU/mL was added dropwise per 9 cm² to a test piece 301 (each of the example 2 and the comparative example 3) and covered with a film 303.

Next, as shown in FIG. 4B, the test piece 301 was allowed to stand at 25° C. for 24 hours while being prevented from drying. The test piece 301 was then washed with 10 mL of a SCDLP medium to recover residual viruses. Next, a 10-fold dilution series of the recovered solution was prepared in an EMEM medium containing 1% penicillin streptomycin.

Next, as shown in FIG. 4C, each of the dilutions were applied to a petri dish 305 cultured with CRFK cells (feline kidney cells) and subsequently cultured (called a plaque method).

Next, as shown in FIG. 4D, live cells were stained and areas that were not stained (cells died and peeled off) were counted. Finally, the virus infection titer was calculated from the count and dilution ratio.

The following formula was used to calculate the virus infection titer.

$$V = ( 10 \times C \times D ) / A$$

V: Viral infection titer per 1 cm² of test piece (PFU/cm²)
C: Plaque count
D: Dilution ratio of washout solution
A: Contact area between test piece and virus

Antiviral activity was calculated according to the following equation.

$$Antiviral activity value = log ( Vb ) - log ( Vc )$$

log(Vb): Common log value of viral infection value per 1 cm² of the example 3 after 24 hours
log(Vc): Common log value of viral infection value per 1 cm² of the comparative example 2 after 24 hours

In the case where the antiviral activity value was 3.0 or more, it was evaluated as having an antiviral effect.

Table 2 summarizes the results of a comparison between a control polyethylene plate, the comparative example 3, and the example 2. Here, the inactivation rate refers to a rate of inactivation of the viruses calculated from the number of active viruses (PFU/mL) in each of the control sample and the test sample. Here, the control sample is the control polyethylene plate, and the test samples are the comparative example 3 and the example 2.

TABLE 2

| | | | | | | Residual Virus Activity | | |
|---|---|---|---|---|---|---|---|---|
| | | PFU/cm² | | | log(PFU/ | | Residual | Inactivation |
| | Time(min) | 1 | 2 | Average | cm²) | R | Rate (%) | Rate (%) |
| control polyethylene | 0 min | 666667 | 1000000 | 833334 | 5.92 | — | — | — |
| plate | 24 hr | 122222 | 133333 | 127778 | 5.11 | — | 100 | — |
| Comparative | 24 hr | 88889 | 100000 | 94445 | 4.98 | 0.13 | 73.9132 | 26.0868 |
| Example 1 | | | | | | | | |
| (Steel plate) | | | | | | | | |
| Example 2 | 24 hr | 111 | 111 | 111 | 2.05 | >3.06 | 0.0869 | 99.9131 |
| (CHX 128 μg/cm²) | | | | | | | | |

When the comparative example 2 is compared with the comparative example 3, the example 2 showed a high antiviral effect with an antiviral activity value of >3.06 and an inactivation rate of 99.9131% after 24 hours.

### Example 3

In this embodiment, the ISO21702 compliance test is performed using influenza viruses A as an enveloped virus in the case where an antiviral agent is applied on a base material.

### Example 3

As the example 3, 4 cm×4 cm of a porous membrane (nanoporous membrane) of 3 μm of alumina (Al₂O₃) was formed on the SUS substrate of 4 cm×4 cm by an AD method. The porous membrane was coated with 16 μg/day of chlorhexidine.

Next, an outline of an antiviral test based on ISO21702 will be described.

As shown in FIG. 4A, 0.225 mL of the virus suspension 302 of the influenza A virus containing 10000000 PFU/mL was dropped per 9 cm² onto the test piece 301 (example 3), and covered with the film 303.

Next, as shown in FIG. 4B, the test piece 301 was allowed to stand at 25° C. for 2 hours while being prevented from drying. Next, the test piece 301 was washed with 10 mL of SCDLP to recover residual viruses. Next, a 10-fold dilution series of the recovered solution was prepared by SCDLP.

Next, as shown in FIG. 4C, each of the dilutions was applied to the petri dish 305 cultured with MDCK cells (canine kidney cells), and subsequently cultured.

Next, as shown in FIG. 4D, live cells were stained and areas that were not stained (cells died and peeled off) were counted. Finally, the virus infection titer was calculated from the count and dilution ratio. Furthermore, the antiviral activity value was calculated in the same manner as in the example 2.

Table 3 is a table summarizing the results of a comparison between a control polyethylene plate and the example 3. Here, the control sample was a control polyethylene plate, and the test sample was the example 3.

TABLE 3

| | | | | | | Residual Virus Activity | | |
|---|---|---|---|---|---|---|---|---|
| | | PFU/cm² | | | log(PFU/ | | Residual | Inactivation |
| | Time(min) | 1 | 2 | Average | cm²) | R | Rate (%) | Rate (%) |
| control polyethylene | 0 min | 562500 | 812500 | 687500 | 5.83 | — | — | — |
| plate | 2 hr | 293750 | 306250 | 300000 | 5.48 | — | 100 | — |
| Example 3 | 2 hr | 178 | 244 | 211 | 2.32 | 3.16 | 0.0703 | 99.9297 |
| (CHX 16 μg/cm²) | | | | | | | | |

The example 3 was confirmed to have a high antiviral effect, with an antiviral activity value of 3.16 and an inactivation rate of 99.9297% after 2 hours. As described above, it was confirmed that, for the example 3, a high antiviral effect can be obtained even in a short time of 2 hours.

### Example 4

Next, the results of verifying that the antiviral effect persists for a long period of time in an article according to an embodiment of the present invention will be described.

### Example 4

First, chlorhexidine was dissolved in acetone so as to be 1 mg/mL. Next, solutions containing chlorhexidine were applied to a SUS substrate of 16 cm². Acetone was then volatilized to apply 125 μg/cm² of chlorhexidine on a base material.

### Comparative Example 4

Chlorhexidine gluconate was dissolved in acetone so as to be 1 mg/mL. Next, solutions containing chlorhexidine gluconate were applied to the SUS substrate of 16 cm². Acetone was then volatilized to apply 125 μg/cm² of chlorhexidine gluconate on a base material.

For the example 4 and the comparative example 4, ultrasonic cleaning was performed for 0 min, 2 min, 10 min, and 30 min, in 60 ml of water at 25° C.

Subsequently, the concentration of chlorhexidine and the concentration of chlorhexidine gluconate eluted in water were measured by UV-Vis (colorimetric method), and an amount of chlorhexidine and an amount of chlorhexidine gluconate remaining on the substrate were back-calculated from the concentration.

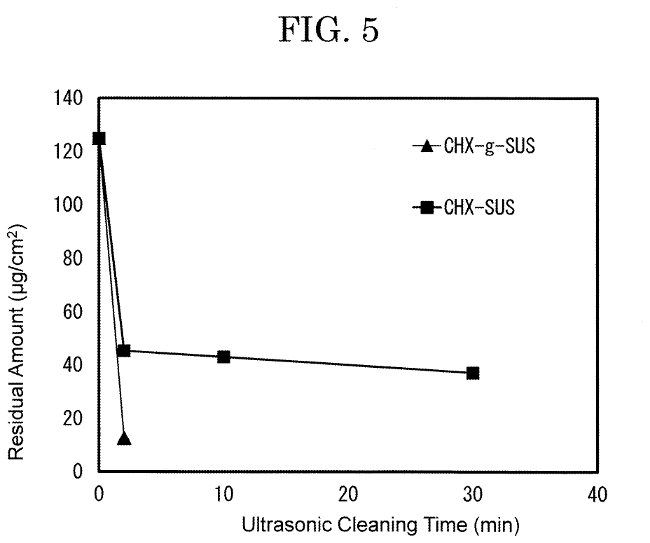

FIG. 5 is a graph showing a relationship between ultrasonic cleaning time (min) and the amount of residual chlorhexidine and the amount of residual chlorhexidine gluconate (μg/cm²). At 2 minutes of the ultrasonic clean time, the residual amount of chlorhexidine was 45.4 μg/cm² and the residual amount of chlorhexidine gluconate was 12.7 μg/cm². At 10 minutes of the ultrasonic cleaning, the residual amount of chlorhexidine was 43.0 μg/cm², and the residual amount of chlorhexidine gluconate could not be calculated. That is, it is considered that all of the chlorhexidine gluconate was eluted in 10 minutes of the ultrasonic cleaning.

As described above, it was suggested that in the case where chlorhexidine gluconate is used as the antiviral agent, when water adheres to the surface of the base material, chlorhexidine gluconate is immediately eluted. On the other hand, it was suggested that in the case where chlorhexidine was used as the antiviral agent, chlorhexidine is hardly eluted even if water adheres to the surface of the base material. Thus, in the article using chlorhexidine as the antiviral agent, the antiviral effect was shown to be sustained for an extended period of time.

### Example 5

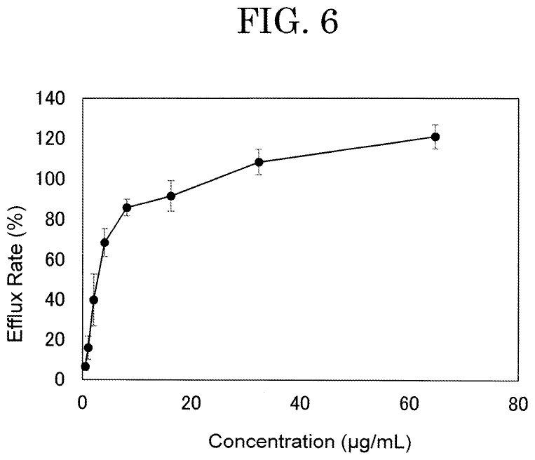

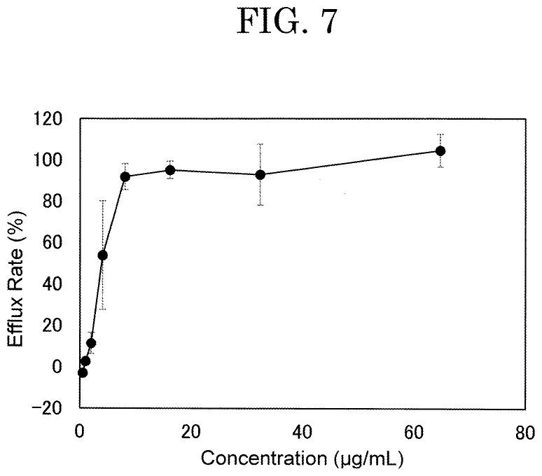

In this example, the results of verifying membrane damage by a surfactant action of chlorhexidine will be described with reference to FIG. 6 to FIG. 7.

First, liposomes simulating virus composition artificial membranes and bacterial composition artificial membranes were prepared.

### Example 5

A method for manufacturing virus composition artificial membranes will be described. First, phosphatidyl choline (PC: phosphatidyl choline) and cholesterol were used to adjust the molar ratio to 4:3.

Next, phospholipids and cholesterol were then dissolved in 1.5 ml of diethyl ether and 1 mL of calcein-KOH (100 mM) was added. This mixture was sonicated for 1 minute in ice using an ultrasonic homogenizer to obtain a homogeneous emulsion.

Next, the diethyl ether in the emulsion was then evaporated under reduced pressure (using an aspirator) by a rotary evaporator at 25° C. and then completely removed by injection of nitrogen gas. The resulting liposomes were centrifuged (100 krpm, 5 min, 4° C.) in a small ultracentrifuge for separation and washed twice with phosphate-buffered saline (PBS: Phosphate-buffered saline; 150 mM NaCl, 10 mM NaH₂PO₄/Na₂HPO₄, pH7.2) to remove calcein-KOH outside liposomes. The resulting liposomes were suspended in PBS to obtain a suspension. The resulting liposomes are also referred to as viral composition artificial membranes.

### Example 6

Next, a method for producing bacterial composition artificial membranes is explained. The bacterial composition artificial membranes were prepared in the same manner as the method for producing the viral composition artificial membranes, except that a molar ratio of 4:1 was prepared using phosphatidylethanolamine (PE: phosphatidylethanolamine) and phosphatidylglycerol (PG: phosphatidylglycerol).

Next, a calcein efflux rate was measured for each of the viral composition artificial membrane and the bacterial composition artificial membrane. PBS, 100 μL of a liposomal suspension encapsulating calcein-KOH (viral composition artificial membrane or bacterial composition artificial membrane), and 20 μL of chlorhexidine dissolved in DMSO (Dimethyl sulfoxide) were added to a microtube to make a total volume of 1 mL. The chlorhexidine was shaken under concentration conditions of 1 μM, 2 μM, 4 μM, 8 μM, 16 μM, 32 μM, 64 μM, and 128 μM.

After shaking at 30° C. for 30 minutes, the mixture was centrifuged (100 krpm, 5 minutes, 4° C.) in a small ultracentrifuge for separation. Thereafter, 0.7 mL of a supernatant liquid was collected, and fluorescence intensity was measured in a vicinity of an excitation wavelength 380 nm and a fluorescence wavelength 520 nm using a fiber multi-spectrometer, and the calcein efflux rate was determined. As a determination of the calcein efflux rate of 0%, PBS, 100 μL of liposome suspension, and 20 μL of DMSO were added to the microtube, and as a determination of the calcein efflux rate of 100%, PBS, 100 μL of liposome suspension, and 10 μL of melittin (final concentration: 20 μM) were added, so that a total volume became 1 mL in each case. Table 4 is a table summarizing the calcein efflux rates of the viral composition artificial membranes and bacterial composition artificial membranes with respect to the concentration of chlorhexidine.

TABLE 4

| | | Calcein Efflux Rate (%) | | | |
|---|---|---|---|---|---|
| | | Virus | | Bacterial | |
| Concentration | | Composition | | Composition | |
| μM | μg/mL | Artificial Membrane | ± | Artificial Membrane | ± |
| 128 | 64.70 | 120.9 | 5.9 | 104.5 | 7.9 |
| 64 | 32.35 | 108.3 | 6.3 | 92.9 | 14.8 |
| 32 | 16.17 | 91.6 | 7.6 | 95.1 | 4.3 |
| 16 | 8.09 | 85.7 | 4.1 | 91.9 | 6.3 |
| 8 | 4.04 | 68.5 | 6.9 | 54.0 | 26.2 |
| 4 | 2.02 | 39.8 | 13.0 | 11.5 | 5.1 |
| 2 | 1.01 | 15.9 | 5.8 | 2.8 | 1.8 |
| 1 | 0.51 | 6.5 | 1.9 | −2.7 | 1.0 |

FIG. 6 shows the results of the calcein efflux rate on the viral composition artificial membranes. FIG. 7 shows the results of the calcein efflux rate on the bacterial composition artificial membranes. The horizontal axes of FIG. 6 and FIG. 7 represent the concentration of chlorhexidine (μg/mL), and the vertical axes represent the calcein efflux rates (%).

As shown in FIG. 6 and FIG. 7, the concentration dependence of the calcein efflux rate on chlorhexidine was confirmed in both the viral composition artificial membrane and the bacterial composition artificial membrane. In addition, it was confirmed that calcein eluted from the virus composition artificial membrane even when the concentration is 0.51 μg/mL (0.000051%). In the bacterial composition artificial membrane, calcein was found to elute even when the concentration is 1.01 μg/mL (0.000101%).

From the above results, it was confirmed that chlorhexidine can form pores in both the artificial viral composition membrane and the artificial bacterial composition membrane so that calcein having a molecular weight of 622.55 can pass through. It has been shown that chlorhexidine has a higher membrane breaking capacity because it can form a much larger pore than the pore size through which ions having a smaller pore size (K+ or H+) can pass. It can also be said that the measurement is in an aqueous solution, and that the chlorhexidine concentration is sufficiently effective at a concentration lower than a solubility of 80 mg/100 mL.

### Example 6

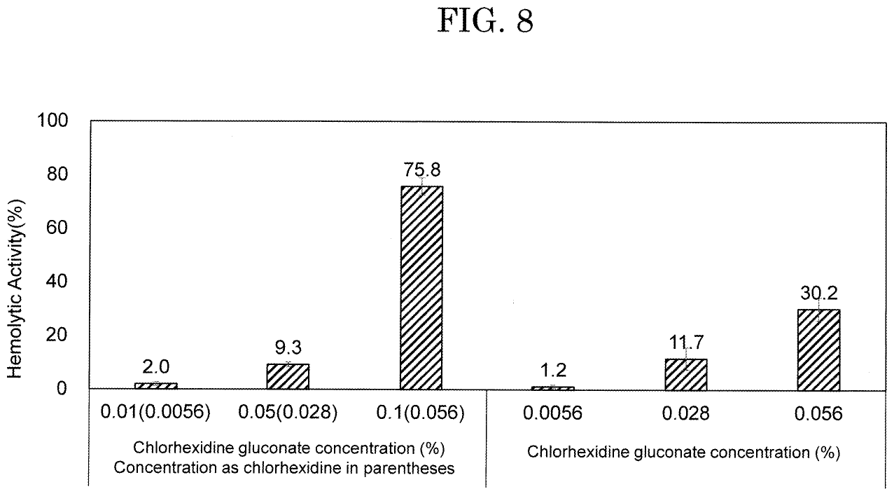

Next, the results of a measurement of chlorhexidine gluconate and chlorhexidine using a destructive action of red blood cells as safety for humans will be described with reference to FIG. 8.

25 μL of sheep defibrillated blood, a Tyrode solution (NaCl 137 mM, KCl 2.7 mM, CaCl₂) 1.0 mM, HEPES 10 mM (pH7.4)), and chlorhexidine gluconate or chlorhexidine solution were mixed. A mixture of 25 μL of sheep defibrillated blood and 975 μL of a Tyrode solution was used as a control, and a mixture of 25 μL of sheep defibrillated blood and 975 μL of purified water was used as a complete hemolysis. The mixtures were left standing at 37° C. for 30 minutes. Thereafter, the mixed liquid is centrifuged, and the supernatant is collected. Absorbance at 545 nm was measured. A hemolysis rate was calculated according to the following formula.

$$[ Mathematical Formula 2 ]$$

$$Hemolysis Rate ( \% ) = 100 \times \frac{( ( Sample Absorbance ) - ( Control Absorbance ) )}{\begin{matrix}( ( Absorbance of Complete Hemolysis ) - \\ ( Control Absorbance ) )\end{matrix}}$$

FIG. 8 shows the results of measuring the destructive effect of red blood cells on chlorhexidine gluconate and chlorhexidine. The horizontal axis represents concentrations of chlorhexidine gluconate and chlorhexidine, and the vertical axis represents hemolytic activity (%). In addition, values in parentheses in the concentration (%) of chlorhexidine gluconic acid are values obtained by converting the concentration of chlorhexidine gluconic acid into the concentration of chlorhexidine.

In 0.05% of chlorhexidine gluconate (molecular weight 897.76) (0.028% for chlorhexidine (molecular weight 505.4)), the hemolytic activity was 9.3%. In contrast, in 0.028% of chlorhexidine, the hemolytic activity was 11.7%. In 0.1% of chlorhexidine gluconate (0.056% for chlorhexidine (molecular weight 505.4)), the hemolytic activity was 75.8%. In contrast, in 0.056% of chlorhexidine, the hemolytic activity was 30.2%. Thus, it was confirmed that 0.056% of chlorhexidine can have lower hemolytic activity compared to 0.1% of (0.056%) chlorhexidine gluconate. Solubility of chlorhexidine is maximally 0.08% (80 mg/100 mL in water solvents), and hemolytic activity can be estimated to be about 50% even at this concentration. This was due to the lower solubility of chlorhexidine compared to chlorhexidine gluconate and indicates a high safety of chlorhexidine in the presence of water. It was shown that it can be used much more safely compared with the conventional chlorhexidine disinfectant when used within the solubility of chlorhexidine (less than 0.08% in water solvent).

### Example 7

Next, the results of the verification of effects of chlorhexidine on bacteria and fungi will be described.

First, a method for measuring the minimum inhibitory concentration on the bacteria will be described. First, 100 μL per hole of a 96-hole test plate was prepared using a Mueller Hinton medium (CAMHB) (and blood added as needed) supplemented with 20 mg/L of Ca²⁺ and 10 mg/L of Mg²⁺ to give a 2-fold dilution series. As a reagent, chlorhexidine was used as an example, and norfloxacin, which is an antibiotic, was used as a comparative example. Each bacterium was cultured in CAMHB (blood added as needed) and added to each of the holes of the test plate at approximately 10000 CFU/mL. The cultures were cultivated at 37° C. for 20 hours, and growth of the bacteria was visually confirmed, and the lowest concentration without growth of the bacteria was defined as the minimum inhibitory concentration (MIC: Minimum Inhibitory Concentration).

As the bacteria, methicillin-sensitive Staphylococcus aureus 209P, methicillin-resistant Staphylococcus aureus N3115, methicillin-resistant Staphylococcus aureus OM584, vancomycin moderate resistant Staphylococcus aureus Mu50, Pseudomonas aeruginosa wild strain PAO1, Pseudomonas aeruginosa resistance gene quadruple disruption strain YM64, Fecaris ATCC29212, Vancomycin-resistant Fecaris ATCC51299, and Vancomycin-resistant Fecaris NCTC12201 were used.

Minimum inhibitory concentrations (MIC) were measured against drug-sensitive bacteria and drug-resistant bacteria. Table 5 shows the minimum inhibitory concentrations (MIC) of chlorhexidine and norfloxacin against the drug-sensitive bacteria and the drug-resistant bacteria.

TABLE 5

| | Chlorhexidine | Norfloxacin |
|---|---|---|
| | (μg/mL) | (μg/mL) |
| Methicillin-sensitive | 0.5 | 2 |
| Staphylococcus | | |
| aureus 209P | | |
| Methicillin-resistant | 1 | 4 |
| Staphylococcus | | |
| aureus N3115 | | |
| Methicillin-resistant | 4 | ≥64 |
| Staphylococcus | | |
| aureus OM584 | | |
| Vancomycin | 2 | ≥64 |
| moderate resistant | | |
| Staphylococcus | | |
| aureus Mu50 | | |
| Pseudomonas | 16 | 2 |
| aeruginosa wild | | |
| strain PAO1 | | |
| Pseudomonas | 2 | 0.12 |
| aeruginosa | | |
| resistance gene | | |
| quadruple disruption | | |
| strain YM64 | | |
| Fecaris ATCC29212 | 2 | 16 |
| Vancomycin- | 4 | 8 |
| resistant Fecaris | | |
| ATCC51299 | | |
| Vancomycin- | 4 | 16 |
| resistant Fecaris | | |
| NCTC12201 | | |

As shown in Table 5, in the case where chlorhexidine was used, it was confirmed that the growth of the methicillin-sensitive Staphylococcus aureus 209P at a concentration of 0.5 g/mL (0.00005%) was inhibited compared to norfloxacin. It was also confirmed that chlorhexidine inhibited the growth of the methicillin-resistant Staphylococcus aureus N3115 at a concentration of 1 μg/mL (0.0001%). It was also confirmed that chlorhexidine inhibited the growth of the vancomycin moderate resistant Staphylococcus aureus Mu50, the Pseudomonas aeruginosa resistance gene quadruple disrupted strain YM64, and the Fecaris ATCC29212 at a concentration of 2 μg/mL (0.0002%). It was also confirmed that chlorhexidine inhibited the growth of the methicillin-resistant Staphylococcus aureus OM584, the vancomycin-resistant Fecaris ATCC51299, and the vancomycin-resistant Fecaris NCTC12201 at a concentration of 4 μg/mL (0.0004%).

As shown in Table 5, it was shown that the use of chlorhexidine can inhibit the growth of bacteria more than when norfloxacin is used. In addition, in the case of the Pseudomonas aeruginosa wild strain PAO1, chlorhexidine was 16 μg/mL (0.0016%), whereas norfloxacin was 2 μg/mL (0.0002%). The case of the Pseudomonas aeruginosa wild strain PAO1 may be a consequence of compatibility with chlorhexidine or norfloxacin. However, even against the Pseudomonas aeruginosa field strain PAO1, since the concentration of chlorhexidine is 16 μg/mL, the growth of bacteria can be sufficiently inhibited.

Next, a method for measuring the minimum inhibitory concentration on fungi will be described. 100 μL per hole in a 96-hole test plate was prepared using RPMI1640 to give a 2-fold dilution series. The bacteria were cultured in the RPMI1640 and added to each of the holes of the test plate at approximately 200 CFU/mL. The cultures were cultivated at 37ºC for 48 hours, and the growth of the bacteria was visually confirmed, and the minimum concentration without the growth of the bacteria was referred as MIC. Candida ATCC12201 was used as the fungi. As a reagent, chlorhexidine was used as an example, and fluconazole of an antifungal agent as an antibiotic was used as a comparative example.

The minimum inhibitory concentration (MIC) was measured against Candida. As a result, the minimum inhibitory concentration was 2 μg/ml (0.0002%) in the case where chlorhexidine was used, compared with 0.25 μg/mL in the case where fluconazole was used. Although the minimum inhibitory concentration in the case where chlorhexidine was used was higher than the case where fluconazole was used, the results were sufficiently low at 2 μg/mL (0.0002%). Therefore, the growth of fungi can be sufficiently inhibited even in the case of Candida.

As described above, it was confirmed that an antibacterial agent and an antifungal agent according to an embodiment of the present invention can inhibit growth of bacteria and fungi by including the low-solubility chlorhexidine having a sufficiently low concentration. It was confirmed that the growth of bacteria and fungi can be prevented and safety to the human body can be ensured by containing 0.00005% of chlorhexidine in the case of the antibacterial agent and 0.0002% of chlorhexidine in the case of the antifungal agent.

What is claimed is:

1. An article having antiviral properties, comprising:
a base material; and
a low-solubility chlorhexidine having solubility of 150 mg/100 mL or less in water at 20° C. is applied on the base material.

2. The article having antiviral properties according to claim 1, wherein the chlorhexidine applied on the base material has a concentration of 0.01 μg/cm² or more and not more than an upper limit concentration C expressed by the following formula (1)
Upper limit concentration C=1000 tpρ[mg/cm²] (1)
where, t (cm) is a thickness of a membrane or layer on a surface to be penetrated, p is a porosity in the case of a porous membrane, and a critical volume ratio (dimensionless) of a penetration component to the base material in the case of a resin material, ρ is a density of the low-solubility chlorhexidine (g/cm³).

3. The article having antiviral properties according to claim 1, wherein the low-solubility chlorhexidine is anion-free chlorhexidine or anion-free chlorhexidine hydrochloride.

4. The article having antiviral properties according to claim 1, wherein the base material is selected from a group consisting of fiber, paper, cloth, resin, metal, or ceramics.

5. An article having antimicrobial properties, comprising:
a base material; and
a low-solubility chlorhexidine having solubility of 150 mg/100 mL or less in water at 20° C. is applied on the base material.

6. The article having antimicrobial properties according to claim 5, wherein the chlorhexidine applied on the base material has a concentration of 0.01 μg/cm² or more and not more than an upper limit concentration C expressed by the following formula (1)
Upper limit concentration C=1000 tpρ[mg/cm²] (1)
where, t (cm) is a thickness of a membrane or layer on a surface to be penetrated, p is a porosity in the case of a porous membrane, and a critical volume ratio (dimensionless) of a penetration component to the base material in the case of a resin material, ρ is a density of the low-solubility chlorhexidine (g/cm³).

7. The article having antimicrobial properties according to claim 5, wherein the low-solubility chlorhexidine is anion-free chlorhexidine or anion-free chlorhexidine hydrochloride.

8. The article having antimicrobial properties according to claim 5, wherein the base material is selected from a group consisting of fiber, paper, cloth, resin, metal, or ceramics.

9. An article having antifungal properties, comprising:
a base material; and
a low-solubility chlorhexidine having a solubility of 150 mg/100 mL or less in water at 20° C. is applied on the base material.

10. The article having antifungal properties according to claim 9, wherein the chlorhexidine applied on the base material has a concentration of 0.01 μg/cm² or more and not more than an upper limit concentration C expressed by the following formula (1)
Upper limit concentration C=1000 tpρ[mg/cm²] (1)
where, t (cm) is a thickness of a membrane or layer on a surface to be penetrated, p is a porosity in the case of a porous membrane, and a critical volume ratio (dimensionless) of a penetration component to the base material in the case of a resin material, ρ is a density of the low-solubility chlorhexidine (g/cm³).

11. The article having antifungal properties according to claim 9, wherein the low-solubility chlorhexidine is anion-free chlorhexidine or anion-free chlorhexidine hydrochloride.

12. The article having antifungal properties according to claim 9, wherein the base material is selected from a group consisting of fiber, paper, cloth, resin, metal, or ceramics.
